(19) United States
(12) Patent Application Publication
(10) Pub. No.: US 2006/0091806 A1
(43) Pub. Date: May 4, 2006

(54) Process for producing luminant excitable with vacuum ultraviolet radiation, luminant excitable with vacuum ultraviolet radiation and luminous element including the same

(75) Inventors: Chaonan Xu, Saga (JP); Wensheng Shi, Beijing (CN); Keiko Nishikubo, Saga (JP); Shuxiu Zhang, Saga (JP); Michio Obata, Saga (JP); Hiroaki Tanno, Saga (JP)

Correspondence Address: DARBY & DARBY P.C., P. O. BOX 5257, NEW YORK, NY, 10150-5257, US

(73) Assignees: National Institute of Advanced Industrial Science and Technology, Tokyo (JP); Daiden Co., Ltd., Fukuoka (JP)

(21) Appl. No.: 10/540,827

(22) PCT Filed: Dec. 26, 2003
(86) PCT No.: PCT/JP03/17077

§ 371 Date: Jun. 24, 2005

(30) Foreign Application Priority Data
Dec. 27, 2002 (JP) 2002-382179

(51) Int. Cl. H01J 17/49

(52) U.S. Cl. 313/587

(57) ABSTRACT

A plasma display panel having its thermal degradation and VUV deterioration reduced through enhancement of the crystallinity of luminant excitable with vacuum ultraviolet radiation to thereby attain an enhancement of luminous efficiency; and a process for producing the same. The plasma display panel comprises a pair of opposite arranged substrates and, interposed therebetween, a phosphor layer that is excited with vacuum ultraviolet radiation to thereby emit light, the phosphor layer containing spherical fine particles of a luminant excitable with vacuum ultraviolet radiation. The luminant is composed only of a matrix substance and an activator and is highly pure without having any impurity phase. Accordingly, the phosphor layer can be formed while maintaining the luminance of luminant excitable with vacuum ultraviolet radiation, so that the luminescence intensity of phosphor layer can be enhanced. Thus, there can be provided a plasma display of high luminance.

### BACKGROUND OF THE INVENTION

1. Field of the Invention

The present invention relates to a luminescent material that is excited by vacuum ultraviolet radiation (VUV) and a process for producing the same. The present invention also relates to a luminous element that uses the same. Described in more detail, the present invention relates to a plasma display panel having a phosphor layer containing spherical fine particles of vacuum ultraviolet radiation (VUV)-excited luminescent material and a process for producing the same. The present invention also relates to spherical fine particles of VUV-excited luminescent material which is suitable for use in a phosphor layer of a plasma display panel, and a process for producing the same.

2. Background Art

With the arrival of the information age, there has been greater demand for large flat displays which are thin and flat. There has been much attention given to plasma display panels (PDP). PDP's are well-suited for image display of digital data such as in wall-mounted TV's, multimedia displays, and the like.

As a result, much research relating to PDP's has been conducted worldwide. Japan has been a world leader in PDP development, and Japan has over 80% of the world's share of PDP's. The production volume of PDP's in 2001 exceeded 200,000 units; in 2002, it exceeded 400,000 units; and in 2005, it is predicted to have a market scale of 6,000,000 units.

In general, PDP's have two glass substrates which are placed parallel and opposite each other. Between the two glass substrates, there are many electric discharge cells. These cells are partitioned by partitioning walls and have rare gas such as Ne and Xe and the like sealed in them. Of the two glass substrates, the glass plate on the observer side of the PDP is the front plate, and the other glass plate is the back plate. An electrode is formed on the front plate on the side towards the back plate. A dielectric layer surrounds this electrode. On top of the dielectric layer, a protective layer (MgO layer) is formed. On the front plate side of the back plate, an address electrode is formed so that it intersects with the electrode formed on the front plate. In addition, a phosphor layer is provided covering the back plate (corresponds to the bottom surface of the cell) and the wall surface of the partitioning wall. By applying alternating current voltage between the electrodes, vacuum ultraviolet radiation is generated by the electric discharge, and as a result of the vacuum ultraviolet radiation, the phosphor emits light. The visible light transmitted through the front plate is observed by the viewer.

In general, PDP's have a lower luminous efficiency as compared to CRT's, and power consumption is high. As a result, in order to have a higher brightness and lower power consumption, PDP's with higher luminous efficiency are needed.

Therefore, in order to heighten the luminous brightness of PDP's, there is a desire to improve the luminous efficiency of the VUV-excited luminescent material.

In PDP's, the VUV-excited luminescent material is used in a phosphor layer in which a luminescent material film is formed. Stated more concretely, a binder resin is added to a VUV-excited luminescent material and made into a paint. After painting uniformly onto a substrate, this is heated in air, and with thermal decomposition of the binder, the phosphor layer is formed.

It is known that the luminous intensity of the phosphor layer is generally lower than the luminous intensity of the VUV-excited luminescent material particles. One reason for this is that when treating with heat to form the phosphor layer, there is oxidation of the activator (main luminescence) of the VUV-excited luminescent material. For example, with BAM (BaMgAl₁₀O₁₇:Eu), which is used as a blue phosphor for PDP's, the activator Eu²⁺ is oxidized to Eu³⁺. This phenomenon is known as heat degradation or baking degradation.

In addition, in PDP's, the VUV-excited luminescent material emits light by having continuous irradiation with vacuum ultraviolet radiation from a Xe gas discharge plasma. Because of this, the luminous intensity of the phosphor layer decreases over time because of the vacuum ultraviolet irradiation. This phenomenon is called VUV deterioration.

Therefore, when creating PDP'S, an important objective is to reduce heat degradation and VUV deterioration of the VUV-excited luminescent material. By reducing these types of deteriorations, the luminous efficiency, which has been a problem with PDP's, is improved, and this could lead to a longer lifespan for the PDP.

In order to improve the luminous efficiency, there must be simultaneously a reduction in the particle size of the VUV-excited luminescent material and improvement in the crystallinity of the phosphor. The VUV-excited luminescent material particles of the prior art contain impurities, and therefore, their purity is low. Because of this, stable crystal structures are not formed. As a result, they are unstable with respect to heat and vacuum ultraviolet radiation, and this is thought to cause heat degradation and VUV deterioration.

Therefore, if the crystallinity of the VUv-excited luminescent material is improved, heat degradation and VUV deterioration can be reduced, and the luminous efficiency is improved.

In order to solve the problems, there has been development of processes for producing phosphors with improved crystallinity. (For example, Patent references 1-3).

Patent Reference 1

Japanese Laid Open Patent Publication Number 11-199867 (Publication date: Jul. 27, 1999)

Patent Reference 2

Japanese Laid Open Patent Publication Number 2002-322469 (Publication date: Nov. 8, 2002)

Patent Reference 3

Japanese Laid Open Patent Publication Number 2002-322470 (Publication date: Nov. 8, 2002)

Stated more concretely, in Patent reference 1, a phosphor such as BAM and the like is produced by a solid phase method. In this production process, alumina of similar particle size is used as raw material. With the solid phase method, when a fluxing agent is added, the resulting phosphor is flat-shaped. When a fluxing agent is not added, the resulting phosphor becomes the same shape as the alumina particle raw material. As a result, with the phosphor obtained by a solid phase method such as in Patent reference 1, spherical alumina particles are used as the raw material. However, it is difficult to obtain perfectly spherical alumina particles, and this increases the cost. On top of this, the luminous brightness of BAM obtained by the solid phase method is low, and it is difficult to reduce heat degradation and VUV deterioration.

In Patent reference 2 and Patent reference 3, aluminum nitrate is used as raw material to produce BAM. Stated more concretely, a nitrate solution of metal which has been measured to have a composition of BAM ((Ba_{0.9}Eu_{0.1})MgAl₁₀O₁₇) is made into droplets by an ultrasonic atomizer. This is then heated to produce BAM.

However with the process in Patent reference 2 and Patent reference 3, metal chlorides or metal hydroxides such as sodium chloride or sodium hydroxide must be added in excess (around 2.5 times the amount of phosphor obtained) to the nitrate solution of the metal which composes BAM. As a result, impurities are easily mixed with the resulting phosphor. BAM is particularly sensitive to the mixing of impurities. With the presence of impurities, the luminous brightness is greatly reduced. In addition, the mixing of impurities can result in heat degradation and VUV deterioration.

In this manner, there are no successful examples of improvements in the crystallinity of the VUV-excited luminescent material and in reducing of the particle size and in controlling the particle shape.

The present invention takes into account the problems of the prior art as described above. The object of the present invention is to improve the crystallinity of the VUV-excited luminescent material, to reduce particle size, and to control the particle shape to a sphere. By doing so, heat degradation and VUV deterioration are reduced. A further object of the present invention is to provide a plasma display panel with improved luminous efficiency and a process for producing the same. In addition, a further object of the present invention is to provide a VUV-excited luminescent material that can be suitably used for a phosphor layer of a plasma display panel and a process for producing the same.

### DISCLOSURE OF THE INVENTION

The present inventors have conducted intensive research into reducing heat degradation and VUV deterioration of VUV-excited luminescent material contained in the phosphor layer of plasma display panels. This resulted in the discovery that by increasing crystallinity (in other words, reducing the amount of defects) and having spherical fine particles of small particle size, the VUV-excited luminescent material has improved heat stability and improved stability with respect to vacuum ultraviolet radiation. The present invention was completed based on these discoveries.

In other words, in order to solve the problems described above, the present invention is a plasma display panel, comprising: a phosphor layer between a pair of opposing substrates; the phosphor layer emitting light through excitation by vacuum ultraviolet radiation; the phosphor layer containing spherical fine particles of luminescent material that is excited by vacuum ultraviolet radiation.

According to the above construction, when vacuum ultraviolet radiation is injected into the phosphor layer, the vacuum ultraviolet radiation phosphor is excited and is converted into visible light. The VUV-excited luminescent material described above has a crystal construction different from the prior art and is a spherical fine particle. This spherical fine particle has improved crystallinity as compared to the prior art, and heat stability and stability with respect to vacuum ultraviolet radiation are improved.

According to this, the heat degradation which occurs when forming the phosphor layer from vacuum ultraviolet radiation phosphor is reduced. In addition, the VUV deterioration in which the luminous intensity is reduced through continuous irradiation with vacuum ultraviolet radiation is lowered.

Therefore, the phosphor layer is formed while maintaining the luminous brightness of the VUV-excited luminescent material. As a result, the luminous intensity of the phosphor layer is improved, and a plasma display panel with high brightness is provided.

The VUV-excited luminescent material described above preferably consists only of a matrix substance and an activator. In other words, the VUV-excited luminescent material described above is a single phase (pure phase) which does not include an impurity phase. As a result, because the purity of the VUV-excited luminescent material is higher, a phosphor layer with an even higher luminous intensity is obtained. As a result, a plasma display panel of high quality is provided.

The VUV-excited luminescent material described above is preferably fine particles of a perfect spherical shape. With this, given luminescent material of the same particle size, perfect spherical particles have the least amount of exposed atoms on the surface, and the heat degradation and VUV deterioration are improved. The crystallinity of the VUV-excited luminescent material is improved.

The VUV-excited luminescent material preferably has a particle size of 2 micrometers or less. The penetration of the vacuum ultraviolet radiation is only approximately 0.2 micrometers. As a result, with large particles, only the portion that does not contribute to light emission increases, and the overall luminous efficiency is low.

According to the above construction, the particle size of the VUV-excited luminescent material contained in the phosphor layer is 2 micrometers or less which is smaller than that of the prior art. When the particle size of the VUV-excited luminescent material is small, the surface area is large, and the luminous efficiency is increased. Therefore, the luminous intensity of the phosphor layer is improved. With this, a plasma display panel of an even greater brightness is provided. In addition, when the particles are small, the packing density is high. The luminous intensity of the phosphor layer is increased, and the phosphor layer can be made thinner to reduce manufacturing costs.

The VUV-excited luminescent material is preferably a BAM type luminescent material that is indicated by BaMgAl₁₀O₁₇:Eu.

According to the construction described above, because the heat stability of the VUV-excited luminescent material is improved, heat degradation is reduced. Therefore, the heat degradation of the blue phosphor containing Eu²⁺ is reduced. Accordingly, a blue color with a chromaticity of high purity is maintained. Accordingly, a stable full color is realized.

Stated differently, the VUV-excited luminescent material is an aluminate-type luminescent material in which the matrix substance includes aluminate.

According to the construction described above, the aluminate luminescent material used in the phosphor layer of the plasma display panel is included as the matrix substance of the VUV-excited luminescent material. Therefore even if the composition of the VUV-excited material is the same as the prior art, because the crystal structure is different, a plasma display with higher brightness than the prior art is provided.

In addition, the VUV-excited luminescent material can be a blue phosphor containing Eu²⁺ as the activator described above.

With plasma display panels, heat degradation of the blue phosphor is particularly large. This is caused by the oxidation of Eu²⁺ to Eu³⁺ generated by heat degradation when forming a phosphor layer. With the plasma display panel, full color is realized by the three colors of red, green, and blue.

The present invention is a process for producing a plasma display panel having a phosphor layer which is placed between a pair of opposing substrates and which contains VUV-excited luminescent material which emits light when excited by vacuum ultraviolet radiation. In a reaction step, a metal ion solution of a VUV-excited luminescent material is atomized, and under a heated atmosphere of 500-1500 degrees C., spherical fine particles are formed. In a baking step, the spherical fine particles formed in the above reaction step is baked by heating to a temperature higher than the reaction step.

According to the above construction, spherical fine particles of the VUV-excited luminescent material are produced in the reaction step. The resulting spherical fine particles have a high purity and do not contain an impurity phase. As a result, crystallinity is good, and spherical particles with small particle size are obtained. In addition, by conducting a baking step, the particle size is made further smaller, and VUV-excited luminescent material with even more improved crystallinity is produced.

Therefore, because heat degradation and VUV deterioration are reduced, a plasma display panel of high brightness is produced.

The heating temperature in the baking step described above is preferably 1000 degrees C. to 1700 degrees C. According to this, crystallinity is improved, and reduction to Eu²⁺ is sufficiently conducted.

In addition, the present invention is a process for producing a plasma display panel having a phosphor layer which is between a pair of opposing substrates and which includes VUV-excited luminescent material that emits light when excited by VUV, comprising: a reaction step in which metal ion solution of the VUV-excited luminescent material is atomized, and spherical fine particles are formed under a heated environment; and a baking step in which the spherical fine particles formed in the reaction step is heated to 1000 degrees C. or greater.

The baking step described above is preferably conducted in an environment with an oxygen concentration of 0.2 ppm or less and 0.5 ppm or less of water. With this environment, VUV-excited luminescent material oxidation which causes heat degradation is prevented. As a result, the luminous intensity of the phosphor layer is further improved.

In the reaction step described above, a fluxing agent or a thickener is preferably added to the metal ion solution described above. Examples of a fluxing agent include aluminum fluoride, ammonium fluoroborate (NH₄BF₄), boric acid, or the like. As a thickener, PVA or the like is added.

Preferably, NH₄BF₄ is added as the fluxing agent described above. With this, the crystallinity of the resulting VUV-excited luminescent material is further improved.

The fluxing agent accelerates the liquid phase formation at high temperatures, and in addition, acts as a reaction catalyst. In addition, the thickener has a role in accelerating the crystallization of the spherical fine particles.

Therefore, by adding the fluxing agent and thickener, the crystallinity of the VUV-excited luminescent material is further improved. As a result, a phosphor layer in which the effect of heat degradation and VUV deterioration is reduced is formed. A plasma display panel which is even brighter is produced.

In order to solve the problems described above, the VUV-excited luminescent material of the present invention is a VUV-excited luminescent material which emits light when excited by vacuum ultraviolet radiation and is a spherical fine particle.

According to this, a VUV-excited luminescent material having a different crystalline construction than the prior art is provided. The crystallinity of the spherical fine particles is better than that of the prior art. The heat stability and stability with respect to vacuum ultraviolet radiation are improved. With this, an ultraviolet radiation-excited luminescent material of high brightness is provided.

The VUV-excited luminescent material is preferably a pure phase consisting only of a matrix substance and an activator. In other words, the VUV-excited luminescent material described above is a single phase containing no impurity phase. Therefore, because the purity of the VUV-excited luminescent material is high, a VUV-excited luminescent material with an even higher luminous intensity is provided.

The VUV-excited luminescent material is preferably a particle size of 2 micrometers or less.

According to the above construction, the particle size of the VUV-excited luminescent material contained in the phosphor layer is 2 micrometers or less and is smaller than the prior art. When the particle size of the VUV-excited luminescent material has a small particle size, the surface area is large, and the luminous efficiency is increased. As a result, the luminous brightness is heightened.

With perfectly spherical particles, the relationship between the surface area and particle size is represented by the following: S(m²/g)=9/[rho(g/cm³)×D (micrometers)]. Here, S is the relative surface area, rho is density (in the case of BaMgAl₁₀O₁₇:Eu, density is 3.7(g/cm³)), and D is the particle diameter. The correlation between surface area and particle diameter of the luminescent spherical particle closely matches this formula. In other words, this confirms that the luminescent material of the present invention is a perfectly spherical particle.

The present invention is a process for producing a VUV-excited luminescent material, comprising: a reaction step, in which a metal ion solution of VUV-excited luminescent material, which emits light when excited by vacuum ultraviolet radiation, is atomized, and spherical fine particles are formed under a heated environment; and a baking step, in which the spherical fine particles formed in the reaction step described above are heated to 1000 degrees C. or greater.

According to the above construction, the spherical fine particles of VUV-excited luminescent material are produced by the reaction step. The resulting spherical fine particles are of high purity and do not include an impurity phase. As a result, crystallinity is good, and spherical fine particles of small particle size are obtained. In addition, by conducting a baking step, the particle size is made further smaller. A VUV-excited luminescent material with further improved crystallinity is produced.

In the reaction step described above, a fluxing agent or thickening agent is preferably further added to the metal ion solution described above. With this, the crystallinity of the VUV-excited luminescent material is further improved.

The baking step described above is preferably conducted under an atmosphere of oxygen concentration of 0.2 ppm or less and water concentration of 0.5 ppm or less. With this, VUV-excited luminescent material oxidation, which causes heat degradation, is prevented. As a result, luminous intensity is further improved.

The VUV-excited luminescent material of the present invention emits light when excited by vacuum ultraviolet radiation and is a spherical fine particle.

The VUV-excited luminescent material described above is preferably perfectly spherical.

The VUV-excited luminescent material described above preferably has a particle size of 2 micrometers or less.

The VUV-excited luminescent material described above is preferably a BAM type luminescent material represented by BaMgAl₁₀O₁₇:Eu.

With this, a VUV-excited luminescent material with improved crystallinity, with small particle size, and with a perfectly spherical shape is provided. As a result, luminous brightness is improved, and VUV deterioration and heat degradation are reduced.

In addition, the method for producing a VUV-excited luminescent material of the plasma display panel of the present invention can also be described as a production process for a VUV-excited luminescent material.

### BRIEF DESCRIPTION OF THE DRAWINGS

FIG. 1 is a scanning electron microscope (SEM) image of BAM prior to baking of Embodiment 1 of the present invention.

FIG. 2 is a scanning electron microscope (SEM) image of BAM after baking of Embodiment 1 of the present invention.

FIG. 3 is a transmission electron microscope (TEM) image of BAM after baking of Embodiment 1 of the present invention.

FIG. 4 is the results of an electron diffraction pattern of BAM after baking of Embodiment 1 of the present invention.

FIG. 5 is the results of a crystal structure analysis of BAM after baking of Embodiment 1 of the present invention.

### DESCRIPTION OF THE PREFERRED EMBODIMENTS

One mode of implementation of the present invention is described below. The present invention is not limited to this description.

(1) Plasma Display Panel and VUV-Excited Luminescent Material of the Present Invention

In the VUV-excited luminescent material of the present invention, when an activator which has been excited by ultraviolet radiation, particularly vacuum ultraviolet radiation, returns to the ground state, visible light is emitted.

With the plasma display panel (PDP) of the present invention, a phosphor layer achieves visible light from the vacuum ultraviolet radiation generated by electric discharge. The phosphor layer contains spherical fine particles of VUV-excited luminescent material. Described in more detail, the phosphor layer is formed by adding a binder resin to spherical fine particles of VUV-excited luminescent material.

The VUV-excited luminescent material described above is a single phase and does not contain impurities and consists only of a matrix substance and the activator, which is the main luminescence.

This matrix substance is an aluminate with the general formula (1)
M¹ₓM²_{y}Al_{z}O_{(2x+2y+3z)/2} (1)
(In the formula, M¹ and M² are alkali earth metals such as Ca, Mg, Ba, and Sr; rare earth metals such as Sc, Y, La, Ce, Pr, Nd, Pm, Sm, Eu, Gd, Th, Dy, Ho, Er, Tm, Yb, and Lu; transitional metal such as Sb, Ti, Zr, V, Cr, Mn, Fe, Co, Ni, Cu, Zn, Nb, Mo, Ta, and W. In addition, a part of M¹ and M² can be substituted with at least one metal selected from the group consisting of alkali metals such as Li, Na, K, Rb, Cs, Fr, and Si, Al, In, Ga, Ge. In addition, x, y, and z are integers).
or a compound represented by the following general formulas (2)-(6)
M³Al₈O₁₃ (2)
M³₄Al₁₄O₂₅ (3)
M³MgAl₁₀O₁₇ (4)
M³₄Al₂SiO₇ (5)
M³₄Mg₂Al₁₆O₂₇ (6)
(in the formula, M³ is at least one metal selected from the group consisting of Ca, Ba, Sr, and Mg)
or a metal oxide such as Al₂O₃, SrO, MgO, ZrO₂, TiO₂, Y₃Al₅O₁₂, ZnO, LiAlO₂, CeMgAl₁₁O₁₉, and the like.

The activator described above is formed from at least one type of rare earth metal or transitional metal. Stated more concretely, the activator is a rare earth metal such as Sc, Y, La, Ce, Pr, Nd, Pm, Sm, Eu, Gd, Th, Dy, Ho, Er, Tm, Yb, Lu, preferably Eu, Tm, Nd, Gd, Th, or a transitional metal such as Sb, Ti, Zr, V, Cr, Mn, Fe, Co, Ni, Cu, Zn, Nb, Mo, Ta, W, preferably Mn, Fe, Cu.

The VUV-excited luminescent material described above is preferably an aluminate-type luminescent material containing an aluminate which is often used in the phosphor layer of PDP's.

Europium-activated barium magnesium aluminate, represented as BaMgAl₁₀O₁₇:Eu, has been implemented for PDP blue color phosphor layer. BaMgAl₁₀O₁₇:Eu has an especially large heat degradation. As a result, the luminous color is shifted to a longer wavelength from the blue region of Eu²⁺, and the luminous intensity is also reduced.

In plasma displays, white color is realized by combining the three colors of red, green, and blue. If any of the colors has a poor luminous quality, an ideal white color is not realized.

According to the present invention, because the VUV-excited luminescent material is a spherical fine particle with improved crystallinity, heat degradation and VUV deterioration are reduced. Because of this, even if the VUV-excited luminescent material is a blue phosphor which contains Eu²⁺ which has an especially large heat degradation, the heat degradation is still reduced. As a result, visible light of high brightness is achieved from the phosphor layer. In other words, a plasma display panel with a high luminous efficiency is provided.

The VUV-excited luminescent material described above has a particle size of preferably 2 micrometers or less, and more preferably 0.2-1.5 micrometers.

Because the VUV-excited luminescent material fine particles of the prior art include an impurity phase, crystallinity is poor. As a result, heat stability and stability with respect to vacuum ultraviolet radiation are also poor, and heat degradation and VUV deterioration are large. As a result, luminous brightness is low.

In contrast, the VUV-excited luminescent material fine particles of the present invention are pure phase VUV-excited luminescent material and are spherical fine particles with improved crystallinity. Because of this, heat stability and stability with respect to vacuum ultraviolet radiation are improved. As a result, luminous brightness is high.

According to the present invention, because the VUV-excited luminescent material is a spherical fine particle with improved crystallinity, heat degradation and VUV deterioration are reduced. Because of this, visible light of high brightness is achieved from the phosphor layer. As a result, a PDP with high luminous efficiency is provided.

(2) Process for Producing a Plasma Display and VUV-Excited Luminescent Material of the Present Invention

The VUV-excited luminescent material of the present invention is produced by the following process. In other words, the production process includes:
(a) a reaction step in which a metal ion solution of VUV-excited luminescent material is atomized, and spherical fine particles are formed under a heated atmosphere;
(b) a baking step in which the spherical fine particles formed in the reaction step described above are baked by heating to 1000 degrees C. or greater.

Step (a) is a step for forming spherical fine particles of VUV-excited luminescent material. In this step, spherical fine particles are achieved by heating and atomizing a metal ion solution which constitutes the VUV-excited luminescent material.

The metal ion solution described above is a solubilized solution of a metal compound of a matrix substance and activator of the VUV-excited luminescent material. Stated more concretely, the metal ion solution is a solution of an inorganic salt such as nitrate, sulfate, chloride and the like or an organic compound such as acetate, alcoholate, and the like of a metal included in the VUV-excited luminescent material.

The amount of the inorganic salt or organic compound is mixed at a proportion corresponding to the constitutive atomic ratio of the metal components in the VUV-excited luminescent material, or in other words of each metal component in the matrix substance and activator. In this situation, the overall metal ion concentration is normally within a range of 0.0001-1.0 mol/L.

As will be described in the embodiments, when producing Eu-activated BAM, the content of Eu as the activator is 1 mol % or greater, and preferably 3-25 mol %, and more preferably 5-15 mol %. With this, a VUV-excited luminescent material of a high luminous intensity is achieved.

For the solvent of the metal ion solution, water or a mixture of water and a water miscible solvent, such as an alcohol type solvent such as ethyl alcohol or a ketone type solvent such as acetone, is used.

For the method for atomizing the metal ion solution, atomized conditions can be achieved readily by a multi-microchannel high pressure atomizing device (nebulizer method) and an ultrasonic atomizer (ultrasonic method).

With the multichannel high pressure atomizing device, the metal ion solution, which is supplied together with pressurized gas, is passed through the small holes of the multichannel to become atomized. The atomized particles are sent to a heating pipe, and by heating the atomized particles, they become vapor particles. The heating temperature is conducted at 500 degrees C. to 1500 degrees C., and preferably 800-1300 degrees C. The heating time is from several seconds to within 1 minute.

By heating for only a small amount of time, drying and baking are conducted simultaneously and instantaneously. As a result, large-sized atomized particles that can be mixed-in are finely broken down, and uniform fine particles are produced. In other words, a particle pulverization step as in the solid phase method of the prior art is not needed.

The pore size of the multichannel is adjusted within the range of 10-1000 micrometers. With this pore size, the atomized particles which are generated are controlled to within a particle size of 0.1-500 micrometers. However, in order to generate a high crystalline spherical fine particle efficiently, microchannels with a pore size of 300 micrometers or smaller is used.

The size of the vapor particle can be selected and controlled as needed by utilizing the spatial distribution. With multi-microchannel atomizers, a gas such as oxygen, nitrogen, argon, dilute hydrogen, or air is pressurized together with the solution in order to convert the solution into an atomized condition. The gas pressure is in the range of 10-500 kPa.

In general, in order to reduce the particle size of atomized particles, a low viscosity raw material solution must be sprayed with a gas with high flow and high pressure. However, by using the multi-microchannel atomizer described above, atomized particles of particle size 20 micrometers or less, which were difficult to obtain with the method of the prior art, are obtained at a low gas pressure of 110 kPa or less.

On the other hand, when an ultrasonic atomizing device is used, the control of the air current is easy. An ultrasonic atomizing device is a simple device in which metal ion solution is atomized by oscillating an ultrasonic oscillator.

By selecting the resonance frequency of the ultrasonic oscillator, the atomized size of the metal ion solution is controlled to a size of 100 nm-10 micrometers. For example, with a resonance frequency of 2.4 MHz, the average size of the atomized metal ion solution was approximately 3 micrometers.

The particles atomized by an ultrasonic atomizing device do not have compositional changes or segregation from the metal ion solution.

In the reaction step, in order to increase the crystallinity of the spherical fine particles, additives such as a fluxing agent or thickener can be added to the metal ion solution described above.

Examples of fluxing agents include aluminum fluoride, ammonium fluoroborate, boric acid, or the like. As a thickener, PVA or the like is added.

The amount of additive is not particularly limited, but around 1 mol %-50 mol % is added.

With this, the crystallinity of the resulting spherical fine particles is improved, and the luminous intensity is heightened. In addition, heat degradation and VUV deterioration are also reduced.

As described above, spherical fine particles of the VUV-excited luminescent material are produced with only the reaction step. However, it is much more preferable to conduct a baking step in which the spherical fine particles formed in the reaction step are baked by heating more than the reaction step.

In the baking step, the heating temperature is a higher temperature than in the reaction step. Stated more concretely, the baking step is conducted at 1000-1700 degrees C., and more preferably at 1300-1500 degrees C. For example, the heating temperature in the baking step is conducted at a temperature about 200 degrees C. higher than the heating temperature of the reaction step described above.

With this, the spherical fine particles obtained in the reaction step are made to have a smaller particle size. As a result, heat degradation and VUV deterioration are reduced.

Furthermore, the baking step described above is preferably conducted in an environment with an oxygen concentration of 0.2 ppm or less and a water content of 0.5 ppm or less. In addition, the gas atmosphere in the baking step described above preferably uses a high purity hydrogen gas and a high purity inert gas (argon, nitrogen, and the like). The gas purity is preferably 99.99% or greater. Oxidation of the VUV-excited luminescent material can cause heat degradation, and with this, oxidation is prevented. As a result, the luminous intensity of the phosphor layer is further improved.

In addition, the reaction step described above can be a preliminary baking step, and the baking step described above can be a main baking step. In other words, with the present production process, by having the heating temperature of the main baking step higher than the temperature in the preliminary baking step, crystallinity is improved, and particle size is reduced, and the particle shape is controlled to be perfectly spherical.

As described above, a VUV-excited luminescent material with a spherical crystal that is different from the prior art is produced. This spherical fine particle has improved crystallinity as compared to the prior art, and heat stability and stability with respect to vacuum ultraviolet radiation are improved.

In order to produce a phosphor layer for a PDP, a binder resin is added to the VUV-excited luminescent material produced by the method described above, and this is made into a paint. After coating uniformly on the substrate, this is heat treated to have heat decomposition of the binder, and the phosphor layer is produced. This phosphor layer has a high luminous brightness, and as a result, a PDP of high brightness is produced.

In addition, the VUV-excited luminescent material is produced by the solid phase method in the prior art. In the solid phase method, raw material for producing a phosphor of a prescribed composition is mixed in a powder form. Next, this is baked at a high temperature of 1500-1800 degrees C. or greater, and there is a solid phase reaction between the raw materials. In addition, in the prior art, a pulverization step, in which the luminescent material particles are pulverized, is needed. However, through pulverization, defects are introduced into the matrix, and this can cause heat degradation and VUV deterioration.

In contrast, with the production process of the present invention, a particle size for the spherical fine particles of 10 nm to 10 micrometers is possible. In addition, the addition of a fluxing agent is not required, and even when a fluxing agent is not added, spherical fine particles with sufficiently high crystallinity and high purity are produced. Furthermore, because the particle size is sufficiently small, pulverization is not needed.

In addition, the heating in the reaction step is conducted only for a few seconds. In other words, spherical fine particles are generated in a short time. In order to improve crystallinity further, there is a baking step. With this, the spherical fine particles are made into finer particles, and the particle size is reduced. As a result, the brightness is even higher. Furthermore, the baking step can be a low temperature baking at around 1000-1500 degrees C., and this is an energy conserving production process.

In addition, in Patent reference 2 and Patent reference 3 mentioned previously, there are described methods for producing BAM by adding metal chlorides or metal hydroxides. However, these patent references and the present invention have the following differences.

Firstly, with the present invention, it is not necessary to add metal chloride or metal hydroxide as a fluxing agent during baking. In other words, there is no mixing of impurities in the luminescent material.

Secondly, in the present invention, the heating temperature of the preliminary baking (reaction step) is lower than the heating temperature of the main baking (baking step). In addition, the temperature of the preliminary baking is 1500 degrees C. or less. In contrast, the heating temperature of the preliminary baking (in the patent reference, this is the heat decomposition synthesis temperature) in Patent references 2 and 3 is 1350-1950 degrees C. The temperature in the main baking (in the patent reference, this is the reheating) is 1000-1700 degrees C., and this is preferably more than 100 degrees C. lower than the temperature of the preliminary baking, and more preferably more than 200 degrees C. lower. When the heating temperature is high, impurities are readily mixed in, and this can lead to reduced luminous brightness. In addition, when the heating temperature of the main baking is lower than the preliminary baking, any matrix defects generated during preliminary baking are not removed. In addition, because there is insufficient reduction to Eu²⁺, the luminous efficiency is low.

In addition, with Patent references 2 and 3, because sodium chloride or sodium nitrate is dissolved in water, solids are readily formed, and there can be segregation of the composition, and the addition of nitric acid is necessary.

In this manner, with the present invention, because the water content in the luminescent material is small, coagulation does not readily occur. In other words, by having the main baking temperature higher than the preliminary baking temperature, the crystallinity of the luminescent material is improved. As a result, luminous brightness is improved.

In contrast, with Patent references 2 and 3, there is baking at high temperature while the water content is still high. As a result, the main luminescence is oxidized, and Eu³⁺ is generated, for example. The Eu³⁺ which is generated does not completely return to Eu²⁺ even when the main baking is conducted under a reducing atmosphere. As a result, luminous intensity is lower.

As will be described in the Embodiments, the BAM obtained by the present invention has a high crystallinity, small particle size, and is a fine particle of a perfectly spherical shape. As a result, luminous brightness is high, and VUV deterioration and heat degradation are reduced.

The present invention is not limited by the implementation modes described above. Various modifications within the scope of the claims are possible, and implementation modes obtained by combining the technical means disclosed in different implementation modes are contained within the technical scope of the present invention.

The present invention will be described in more detail based on the embodiments. The present invention is not limited to these embodiments.

### Embodiment 1

(1) A raw material solution was obtained by dissolving 0.018 mol of barium nitrate (Ba(NO₃)₂), 0.02 mol of Mg(NO₃)₂—6H₂O, 0.2 mol of Al(NO₃)₃—9H₂O, 0.002 mol of Eu(NO₃)₃—2.4H₂O in 1 L of distilled water. This raw material solution was introduced into a microchannel atomizing device at a rate of 100 mL per hour and was atomized as a micromist. Together with 5% Ar—N₂ gas, this was introduced into a tubular electric furnace set at 1300 degrees C. This was heated for 3 seconds while passing through (reaction step). The resulting spherical fine particles were collected by a collection apparatus. With electron microscope observation and particle distribution analysis, the resulting particles were seen to be truly spherical with average particle diameter D₅₀ of 1.0 micrometers.

The luminous intensity when the luminescent particles are used in a plasma display is shown in Table 1. In the table, heat degradation was evaluated as the maintenance rate of luminous intensity after 30 minutes of heat treatment of the coating at 500 degrees in air. In addition, VUV deterioration was evaluated as the maintenance rate of luminous intensity after 22 hours of irradiation in a plasma irradiation accelerated test tube.

TABLE 1

| | | | | Heat | VUV |
|---|---|---|---|---|---|
| Sample | Addition of flux | Baking conditions | Luminous intensity | degradation | deterioration |
| Comparative example | — | 1500° C., 5 hours | 100 | 60 | 30 |
| Embodiment 1 | — | Immediately after | 50 | — | — |
| | | atomization | | | |
| | — | 1400° C., 4 hours | 117 | 70 | 40 |
| Embodiment 2 | — | 1500° C., 4 hours | 120 | 80 | 45 |
| Embodiment 3 | — | 1500° C., 3 hours | 110 | 87 | 42 |
| Embodiment 4 | 8% AIF₃ | 1500° C., 5 hours | 121 | 89 | 68 |
| Embodiment 5 | 5% NH₄BF₄ | 1500° C., 2 hours | 115 | 85 | 60 |
| Embodiment 6 | 5% H₃BO₃ | 1500° C., 3 hours | 116 | 86 | 61 |
| Embodiment 7 | 0.02% PVA | 1400° C., 4 hours | 104 | 75 | 46 |

As shown in Table 1, even when baking for an extremely short time (several seconds), a luminous intensity of 50% or greater was obtained from spherical fine particles immediately after atomization. With the same baking times, the ones produced by the solid phase method did not emit any light. In order to improve luminous intensity, decrease heat degradation and VUV deterioration, and improve luminous intensity and its stability, baking (baking step) was conducted.

(2) Study of Baking Temperatures

Table 2 shows the luminous intensities according to the re-baking temperature. The re-baking temperatures were effective if they were higher than the atomization temperature. In this situation, the re-baking temperature was effective at 1300 degrees or greater. With the method of the prior art, because a crystal phase was not formed at such a low temperature, luminescent particles were not formed. On the other hand, the luminescent particles produced in the present embodiments all had a pure phase of BaMgAl₁₀O₁₇, with no impurity phase.

Not only was the luminous intensity high, but color was excellent. These are advantageous for the quality of the plasma display. The present method forms a pure phase at extremely low temperatures.

TABLE 2

| Sample | Baking conditions | Luminous intensity |
|---|---|---|
| Comparative example | 1500° C., 5 hours | 100 |
| Embodiment 1 | — | 50 |
| | 1300° C., 3 hours | 105 |
| | 1400° C., 4 hours | 117 |
| | 1500° C., 5 hours | 120 |

A film with a luminous intensity of 117% was obtained by re-baking for 4 hours at 1400 degrees C. in a 4% H₂—N₂ atmosphere. The luminance intensity maintenance rate after heat degradation and the luminance intensity maintenance rate after VUV deterioration were both increased by 10%.

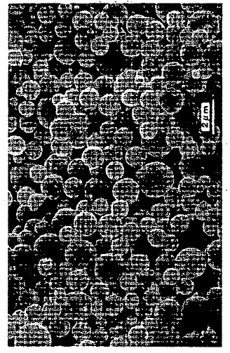

Various analyses were conducted on the BAM crystals obtained with the present embodiments (FIGS. 1-5).

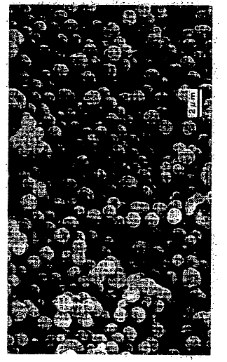

FIG. 1 is an SEM image of the spherical particles of BAM prior to re-baking (after the reaction step). FIG. 2 is a SEM image after re-baking (final product). As shown by these Figures, both BAM's are perfectly spherical, and by re-baking, BAM with smaller particle size is obtained without any coagulation.

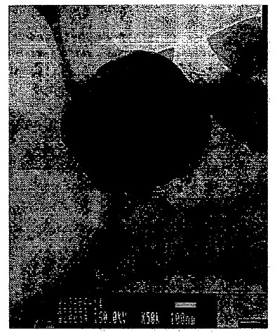

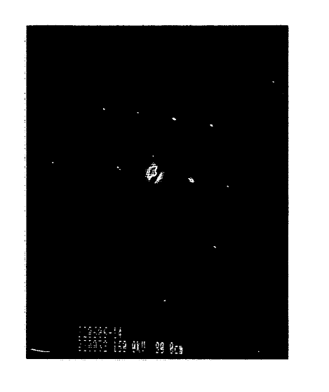

FIG. 3 shows a TEM image of the BAM of the final product. The spherical particles in the center are the BAM. The particle diameter is approximately 300 nm. FIG. 4 is an electron diffraction pattern of the BAM of the final product. This confirms that the crystallinity is high.

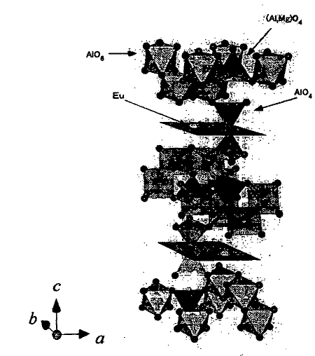

FIG. 5 shows the results of the crystal structure analysis of the BAM of the final product. With crystal structure analyses of BAM, because the crystallinity of BAM of the prior art was poor, there was no clear understanding of the structure. The BAM obtained in the present invention has good crystallinity and does not contain impurities. As a result, the crystal structure can be understood better.

According to X-ray diffraction pattern analysis, the average particle size of BAM of Embodiment 1 was a crystallite size in the C-axis of 154 nm, and a crystallite size in a direction perpendicular to the C-axis of 496 nm. The ratio of the crystallite size in the direction perpendicular to the C-axis to the crystallite size in the C-axis direction was 3.2, and this was larger than 2.5. In addition, the matrix constant c was 2.2625 nm, and this was smaller than 2.2630 nm. Similar results were obtained with Embodiments 2-7 of the present invention as shown in Table 1.

### Embodiment 2

### Example of Ultrasonic Type Atomizer

A raw material solution was obtained by dissolving 0.18 mol of barium acetate (Ba(CH₃COO)₂), 0.2 mol of Mg(NO₃)₂—6H₂O, 2 mol of Al(NO₃)₃—9H₂O, 0.02 mol of Eu(NO₃)₃—2.4 H₂O in 3 L of distilled water. This raw material solution was introduced into an ultrasonic atomizing device at a speed of 200 mL/hour and was atomized to a micromist. Together with 5% H₂—N₂ gas, the micromist was introduced into a tubular electric furnace set at 1300 degrees, and reaction baking was conducted. The resulting spherical fine particles were collected with a collection apparatus and maintained at 100 degrees. The resulting particles were spherical with an average particle size of 1.0 micrometers.

Even with a very short baking time (seconds), the spherical fine particles had a luminous intensity of 60% or greater immediately after atomization. With similar baking times, ones produced by the solid phase reaction method did not emit any light.

In this situation, in order to improve luminous intensity and stability of the same, baking was effective.

When the spherical particles were re-baked for 5 hours in a 4% H₂—N₂ atmosphere at 1400 degrees, the luminous intensity, heat degradation, VUV deterioration were greatly improved. A film with 120% luminous intensity was obtained. In addition, heat degradation and VUV deterioration were improved 20% and 15%, respectively.

### Embodiment 3

A raw material solution was obtained by dissolving 0.018 mol of barium nitrate (Ba(NO₃)₂), 0.02 mol of Mg(NO₃)₂—6H₂O, 0.2 mol of Al(NO₃)₃—9H₂O, 0.002 mol of Eu(NO₃)₃—2.4 H₂O in 3 L of distilled water. This raw material solution was introduced into an ultrasonic atomizing device at a speed of 200 mL/hour and was atomized to a micromist. Together with 5% H₂—N₂ gas, the micromist was introduced into a tubular electric furnace set at 1300 degrees, and reaction baking was conducted. The resulting spherical fine particles were collected with a collection apparatus and maintained at 100 degrees. The resulting particles were spherical with an average particle size of 0.5 micrometers. After re-baking, the particle size was slightly smaller than after atomization and was 0.45 micrometers. The luminous properties were similarly improved (see Table 1).

### Embodiment 4 an Example Using AlF₃

A raw material solution was obtained by dissolving 0.018 mol of barium nitrate (Ba(NO₃)₂), 0.02 mol of Mg(NO₃)₂—6H₂O, 0.2 mol of Al(NO₃)₃—9H₂O, 0.002 mol of Eu(NO₃)₃—2.4 H₂O, and 0.0016 AlF₃ in 2 L of distilled water. This raw material solution was introduced into an ultrasonic atomizing device at a speed of 200 mL/hour and was atomized to a micromist. Together with 5% H₂—N₂ gas, the micromist was introduced into a tubular electric furnace set at 800 degrees, and reaction baking was conducted. The resulting spherical fine particles were collected with a collection apparatus. The resulting particles were spherical with an average particle size of 1.0 micrometers. By adding a flux, the luminous properties and deterioration properties were further improved (see Table 1).

### Embodiment 5

### Example Using NH₄BF₄

A raw material solution was obtained by dissolving 0.018 mol of barium nitrate (Ba(NO₃)₂), 0.02 mol of Mg(NO₃)₂—6H₂O, 0.2 mol of Al(NO₃)₃—9H₂O, 0.002 mol of Eu(NO₃)₃—2.4 H₂O, and 0.01 NH₄BF₄ in 2 L of distilled water. This raw material solution was introduced into an ultrasonic atomizing device at a speed of 200 mL/hour and was atomized to a micromist. Together with 5% H₂—N₂ gas, the micromist was introduced into a tubular electric furnace set at 600 degrees, and reaction baking was conducted. The resulting spherical fine particles were collected with a collection apparatus. The resulting particles were spherical with an average particle size of 1.0 micrometers. By adding a flux, the luminous properties and deterioration properties were further improved (see Table 1).

### Embodiment 6

### Example Using H₃BO₃

Luminescent particles were obtained by the same method as in Embodiment 5, except that instead of NH₄BF₄, 0.01 mol of H₃BO₃ was used. The resulting particles were spherical with an average particle size of 1.1 micrometers.

### Embodiment 7 Example Using PVA

Luminescent particles were obtained by the same method as in Embodiment 5, except that instead of NH₄BF₄, 0.0004 mol of PVA was used. The average particle size was 1.3 micrometers.

### Embodiment 8

### Example Using Citrate Solution

In 1 L distilled water, 0.2 mol of Al(NO₃)₃—9H₂O was dissolved . This was neutralized with aqueous ammonia NH₃—H₂O. The generated sol was filtered and rinsed repeatedly to remove nitrate ion. Next, this was dissolved in citric acid together with barium carbonate and europium oxide to create a raw material solution. Together with this, up to pH of 8, 0.018 mol of barium nitrate (Ba(NO₃)₂, 0.02 mol of Mg(NO₃)₂—6H₂O, and 0.002 mol of Eu(NO₃)₃—2.4H₂O were dissolved in 3 L of distilled water to make a raw material solution. This raw material solution was introduced into an ultrasonic atomizing device at a speed of 200 mL/hour and was atomized to a micromist. Together with oxygen gas, the micromist was introduced into a tubular electric furnace set at 1500 degrees, and reaction baking was conducted. The resulting spherical fine particles were collected with a collection apparatus and maintained at 100 degrees. The resulting particles were spherical with an average particle size of 1.5 micrometers.

### Embodiment 9

### Example of Eu with a Changed Composition

Experiments were conducted with the same method as the embodiments described above, except that the addition amount of Eu was changed. The relationship between the addition amount of Eu and luminous intensity was studied.

The results are shown in Table 3. With addition of 1%, a luminous intensity of 40% was obtained. With an addition amount of 5-14%, the luminous intensity was hardly changed. All of these had a higher luminous intensity as compared to the comparative examples.

TABLE 3

| | | Baking | Luminous |
|---|---|---|---|
| Sample | | conditions | intensity |
| Comparative | Eu_{0.1}Ba_{0.9}MgAl₁₀O₁₇ | 1500° C., | 100 |
| example | | 5 hours | |
| Embodiment 9 | Eu_{0.01}Ba_{0.99}MgAl₁₀O₁₇ | 1400° C., | 40 |
| | | 2 hours | |
| Embodiment 9 | Eu_{0.03}Ba_{0.97}MgAl₁₀O₁₇ | 1400° C., | 90 |
| | | 2 hours | |
| Embodiment 9 | Eu_{0.05}Ba_{0.85}MgAl₁₀O₁₇ | 1400° C., | 102 |
| | +0.1% AIF₃ | 2 hours | |
| Embodiment 9 | Eu_{0.07}Ba_{0.93}MgAl₁₀O₁₇ | 1400° C., | 105 |
| | +0.1% AIF₃ | 2 hours | |
| Embodiment 9 | Eu_{0.14}Ba_{0.86}MgAl₁₀O₁₇ | 1400° C., | 108 |
| | +0.1% AIF₃ | 2 hours | |

### Embodiment 10

With the Embodiments 1-9, re-baking was conducted in an atmosphere of oxygen concentration of 0.2 ppm or less, and re-baking was conducted while changing the gas purity. The baking was conducted at a temperature of 1400 degrees C. for 2 hours. The results are shown in Table 4. As shown in Table 4, with a normal ultraviolet radiation (254 nm), there was no difference in luminous intensity. However, when excited by vacuum ultraviolet radiation (147 nm) the luminous intensity was improved a further 5-20%. In addition, the luminous intensity was highest when oxygen concentration and water content was controlled. At the same time, VUV deterioration and heat degradation was greatly improved. When oxygen concentration was 0.002 ppm or less and water concentration was 0.5 ppm or less, the luminous intensity was improved without adding a fluxing agent.

In addition, greater improvement was seen with smaller average particle sizes. In addition, oxygen trapping and water trapping was conduced using an oxygen filter and water filter.

TABLE 4

| | | Luminous | Luminous |
|---|---|---|---|
| | | intensity | intensity |
| | Baking conditions | (147 nm) | (254 nm) |
| Embodiment 10 | 5% H₂—N₂ (99.99%) | 100 | 100 |
| | 5% H₂—N₂ (99.9%) | 90 | 98 |
| | 5% H₂—N₂ (99.999%) | 110 | 101 |
| | 5% H₂—N₂ (99.999%) | 109 | 101 |
| | 5% H₂—N₂ (99.99%) | 120 | 102 |
| | O₂ trap (0.002 ppm or | | |
| | less) | | |
| | 5% H₂—N₂ (99.99%) | 125 | 103 |
| | O₂ trap (0.002 ppm or | | |
| | less) | | |
| | H₂O trap (0.5 ppm or | | |
| | less) | | |

### COMPARATIVE EXAMPLE 1

Using the solid phase method, (Ba_{0.9}Eu_{0.1})MgAl₁₀O₁₇ was produced. In this situation, even when baked for 5 hours at 1500 degrees, without a flux, a single phase of BaMgAl₁₀O₁₇ was not formed, and there was a co-existing impurity phase. Not only did the resulting BAM have a low luminous intensity, there was a shifting of color, and this was not good for the quality of plasma display.

The crystallite size in the C-axis direction of BAM of Comparative example 1 was 503 nm. The crystallite size in the direction perpendicular to the C axis was 1032 nm. The ratio of the crystallite size in the direction perpendicular to the C-axis and the crystallite size in the C-axis direction was smaller than 2.5. In addition the matrix constant c was 2.2630. The same analysis results were obtained with Comparative example 2 described below.

### COMPARATIVE EXAMPLE 2

Using the same method as Patent reference 1, (Ba_{0.9}Eu_{0.1})MgAl₁₀O₁₇ was produced. In other words, barium carbonate, europium oxide, and basic magnesium carbonate were measured out to produce (Ba_{0.9}Eu_{0.1})MgAl₁₀O₁₇. This was baked for 5 hours in an electric furnace of 1500 degrees C. in an atmosphere of 5% H₂—N₂. The luminous intensity at 147 nm of the resulting BAM was measured and it was 100. Because this uses a solid phase reaction, the results are thought to be the same as Comparative example 1.

### COMPARATIVE EXAMPLE 3

Barium nitrate, europium nitrate, and aluminum nitrate were measured out to make (Ba_{0.9}Eu_{0.1})MgAl₁₀O₁₇ and were dissolved in water. Sodium chloride was added to this solution, and nitric acid was added to make a pH of 0.8. This solution was atomized by an ultrasonic atomizing device having an oscillation of 2.1 MHz. With everything else the same as in the method of Embodiment 2 of Patent reference 2, BAM was produced. The luminous intensity of the resulting BAM was lower than that of Comparative example 1. This may be because the temperature in the baking step was lower than the temperature in the reaction step, and thus the reduction to Eu²⁺, which is the main luminescence, is inadequate. In addition, because it was heated at 1600 degrees C. for only 10 seconds, the resulting crystal was incomplete. In addition, the added sodium chloride remained as impurities to create a non-radiative center. As a result, the BaMgAl₁₀O₁₇:Eu obtained by the method in Patent reference 2 had poor luminous qualities. In addition, because sodium chloride and water remains, there is considerable amount of condensation when the baking temperature is high. As a result, high temperature baking is not possible.

### COMAPARATIVE EXAMPLE 4

(Ba_{0.9}Eu_{0.1})MgAl₁₀O₁₇ was produced by the same method as Comparative example 3, except that instead of sodium chloride, sodium nitrate was used (method in Patent reference 3). As in Comparative example 3, the resulting (Ba_{0.9}Eu_{0.1})MgAl₁₀O₁₇ had a lower luminous intensity compared to Comparative example 1. Table 5 shows the luminous intensity by VUV-excitation of BAM of Comparative examples 1-4.

In the present invention, when the reduction to Eu²⁺ is inadequate, the matrix constant C becomes longer. In particular, when C becomes longer than 2.2630 nm, not only is the luminous efficiency lower, but heat degradation and VUV deterioration occurs more readily. In addition, when crystallinity is low, the ratio of the crystallite size in the direction perpendicular to the C-axis to the crystallite size in the C axis direction becomes smaller. In particular, when the ratio of the crystallite size in the direction perpendicular to the C axis to the crystallite size in the C axis is smaller than 2.5, the luminous efficiency is lower, and degradation occurs more readily.

TABLE 5

| | Luminous intensity |
|---|---|
| Comparative example 1 | 100 |
| Comparative example 2 | 100 |
| Comparative example 3 | 92 |
| Comparative example 4 | 88 |

### POSSIBLE USES IN INDUSTRY

As described above, the present invention is a plasma display panel, comprising: a phosphor layer between a pair of opposing substrates; the phosphor layer emitting light when excited by vacuum ultraviolet radiation; the phosphor layer containing spherical fine particles of luminescent material that is excited by vacuum ultraviolet radiation.

The spherical fine particles have improved crystallinity as compared to the prior art, and heat stability and stability with respect to vacuum ultraviolet radiation are improved.

With this, the heat degradation, which occurs when forming a phosphor layer from a VUV phosphor, is reduced. In addition, the VUV deterioration in which luminous intensity is lowered by continuous irradiation with vacuum ultraviolet radiation is also reduced.

Therefore, the phosphor layer is formed while maintaining the luminous brightness of the VUV-excited luminescent material. As a result, the luminous intensity of the phosphor layer is improved, and a plasma display with high brightness is provided.

In addition, the present invention is a process for producing a plasma display panel in which a phosphor layer is between a pair of opposing substrates and contains VUV-excited luminescent material which emits light when excited by vacuum ultraviolet radiation. In a reaction step, metal ion solution of VUV-excited luminescent material is atomized, and under a heated atmosphere, spherical fine particles are formed. In a baking step, the spherical fine particles formed in the above reaction step are baked by heating to a temperature of 1000 degrees C. or greater.

Spherical fine particles of VUV-excited luminescent material are produced by this method. The resulting spherical fine particles consist only of matrix substance and activator. The spherical fine particles are of high purity and do not contain an impurity phase. As a result, crystallinity is good, and spherical fine particles of small particle size is obtained. In addition, by conducting a baking step, the particle size is made further smaller, and a VUV-excited luminescent material with even more improved crystallinity is produced.

As a result, heat degradation and VUV deterioration are reduced, and a plasma display panel of high brightness is produced.

What is claimed is:

1. A plasma display panel, comprising:
a phosphor layer between a pair of opposing substrates;
said phosphor layer emitting light through excitation by vacuum ultraviolet radiation;
said phosphor layer containing spherical fine particles of a luminescent material that is excited by vacuum ultraviolet radiation (VUV).

2. A plasma display panel as described in claim 1, wherein:
said VUV-excited luminescent material is fine particles of a perfect sphere-shape.

3. A plasma display panel described in claim 2, wherein:
said VUV-excited luminescent material has a particle size of 2 micrometers or less.

4. A plasma display panel described in claim 2 or 3, wherein:
said VUV-excited luminescent material is a BAM-type luminescent material represented by BaMgAl₁₀O₁₇:Eu.

5. A process for producing a plasma display panel having a phosphor layer which is placed between a pair of opposing substrates and which contains a VUV-excited luminescent material which emits light through excitation by vacuum ultraviolet radiation, comprising:
a reaction step in which a metal ion solution of VUV-excited luminescent material is atomized and formed into spherical fine particles under a heated atmosphere of 500-1500 degrees C.;
a baking step in which said spherical particles formed in said reaction step are heated to a temperature greater than in said reaction step.

6. A process for producing a plasma display panel as described in claim 5, wherein:
said heating temperature of said baking step is 1000-1700 degrees C.

7. A process for producing a plasma display panel as described in claim 5 or 6, wherein:
said baking step is conducted in an atmosphere of oxygen concentration of 0.02 ppm or less and water concentration of 0.5 ppm or less.

8. A process for producing a plasma display panel as described in claims 5, 6 or 7, wherein:
in said reaction step, a fluxing agent or thickener is further added to said metal ion solution.

9. A process for producing a plasma display panel as described in claim 8, wherein:
NH₄BF₄ is added as said fluxing agent.

10. A VUV-excited luminescent material, comprising:
VUV-excited luminescent material which emits light through excitation by vacuum ultraviolet radiation;
said VUV-excited luminescent material being fine particles of perfectly spherical shape.

11. A process for producing VUV-excited luminescent material as described in claim 10, comprising:
a reaction step in which a metal ion solution containing a matrix substance and an activator which constructs said VUV-excited luminescent material is atomized and formed into spherical fine particles under a heated atmosphere of 500-1500 degrees C.;
a baking step in which said spherical particles formed in said reaction step are heated to a temperature greater than said reaction step.
